(19) United States
(12) Patent Application Publication
(10) Pub. No.: US 2020/0122856 A1
(43) Pub. Date: Apr. 23, 2020

(54) FLIGHT CONTROL SAFETY SYSTEM

(71) Applicant: Chinedum Uzochukwu Esimai, Houston, TX (US)

(72) Inventor: Chinedum Uzochukwu Esimai, Houston, TX (US)

(21) Appl. No.: 16/546,116

(22) Filed: Aug. 20, 2019

Related U.S. Application Data
(60) Provisional application No. 62/747,246, filed on Oct. 18, 2018.

(51) Int. Cl. B64D 45/00; G05B 9/03; B64D 17/62; B64D 25/00; B64D 15/22; B64D 31/06; B64C 25/42; B64C 19/02

(52) U.S. Cl. CPC B64D 45/00; G05B 9/03; B64D 17/62; B64D 25/00; B64D 2045/0085; B64D 31/06; B64C 25/426; B64C 19/02; B64D 15/22

(57) ABSTRACT

Embodiments of the present invention disclose a method, a computer program product, and a system for detecting a flight emergency and executing solutions for the emergency. Embodiments of the present invention describe a method comprising: receiving a sensor alert, executing an alert solution associated with the sensor alert, determining flight condition, determining flight condition is a crash condition, and deploying a set of parachutes.

### CLAIM OF PRIORITY

This application claims the benefit of U.S. Provisional Application No. 62/747,246, filed 18 Oct. 2018. The information contained therein is hereby incorporated by reference.

### BACKGROUND

### 1. Field of the Invention

The present application relates to the field of flight control systems, and more particularly to emergency deployment systems.

### 2. Description of Related Art

Commercial airline travel has become a common form of travel, and with its use of high speeds, volatile fuels, and large pressure differentials comes its dangers. Various safety measures have been developed to minimize aircraft damage and prevent casualties as a results of aircraft hardware failure. For example, emergency features of aircraft commonly include emergency exit doors, passenger floatation devices, inflatable rafts, inflatable slides, and deployable oxygen masks. While these solutions provide safety for passengers once the plane has landed, there are limited options during a mid-flight emergency. For example, significant power loss though multiple engine failure, engine and/or fuel reservoir fire, accumulated ice, landing gear malfunction, or fuel depletion can result in swift disaster. It is desired to develop a system that manages flight controls during an emergency and deploys emergency equipment in the event of a mid-flight emergency.

### SUMMARY OF THE INVENTION

Embodiments of the present invention disclose a method, a computer program product, and a system for detecting a flight emergency and executing solutions for the emergency. In one embodiment of the present invention, a method is provided comprising: receiving a sensor alert, executing an alert solution associated with the sensor alert, determining flight condition, determining flight condition is a crash condition, and deploying a set of parachutes.

Ultimately the invention may take many embodiments. In these ways, the present invention overcomes the disadvantages inherent in the prior art.

The more important features have thus been outlined in order that the more detailed description that follows may be better understood and to ensure that the present contribution to the art is appreciated. Additional features will be described hereinafter and will form the subject matter of the claims that follow.

Many objects of the present application will appear from the following description and appended claims, reference being made to the accompanying drawings forming a part of this specification wherein like reference characters designate corresponding parts in the several views.

Before explaining at least one embodiment of the present invention in detail, it is to be understood that the embodiments are not limited in its application to the details of construction and the arrangements of the components set forth in the following description or illustrated in the drawings. The embodiments are capable of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the various purposes of the present design. It is important, therefore, that the claims be regarded as including such equivalent constructions in so far as they do not depart from the spirit and scope of the present application.

### DESCRIPTION OF THE DRAWINGS

The novel features believed characteristic of the application are set forth in the appended claims. However, the application itself, as well as a preferred mode of use, and further objectives and advantages thereof, will best be understood by reference to the following detailed description when read in conjunction with the accompanying drawings, wherein:

FIG. 1 is a functional block diagram illustrating a communication environment, in accordance with an embodiment of the present application;

FIG. 2 illustrates various subsystems of a flight control system, in accordance with an embodiment of the present invention;

FIG. 3 illustrates various subsystems of an emergency control system, in accordance with an embodiment of the present invention;

FIG. 4 is a flowchart depicting operational steps of an emergency program executing solutions for a flight emergency, in accordance with an embodiment of the present invention;

FIG. 5 is a side view of an aircraft outfitted with emergency control systems, in accordance with an embodiment of the present invention;

FIG. 6 is a top view of an aircraft outfitted with emergency control systems, in accordance with an embodiment of the present invention; and

FIG. 7 depicts a block diagram of components of the computing systems of FIG. 1, in accordance with an embodiment of the present invention.

While the embodiments and method of the present application is susceptible to various modifications and alternative forms, specific embodiments thereof have been shown by way of example in the drawings and are herein described in detail. It should be understood, however, that the description herein of specific embodiments is not intended to limit the application to the particular embodiment disclosed, but on the contrary, the intention is to cover all modifications, equivalents, and alternatives falling within the spirit and scope of the process of the present application as defined by the appended claims.

### DETAILED DESCRIPTION OF THE PREFERRED EMBODIMENT

Illustrative embodiments of the preferred embodiment are described below. In the interest of clarity, not all features of an actual implementation are described in this specification. It will of course be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming but would nevertheless be a routine undertaking for those of ordinary skill in the art having the benefit of this disclosure.

In the specification, reference may be made to the spatial relationships between various components and to the spatial orientation of various aspects of components as the devices are depicted in the attached drawings. However, as will be recognized by those skilled in the art after a complete reading of the present application, the devices, members, apparatuses, etc. described herein may be positioned in any desired orientation. Thus, the use of terms to describe a spatial relationship between various components or to describe the spatial orientation of aspects of such components should be understood to describe a relative relationship between the components or a spatial orientation of aspects of such components, respectively, as the embodiments described herein may be oriented in any desired direction.

Embodiments of the present invention overcomes one or more of the above-discussed problems commonly associated aircraft emergencies. The embodiments of the present invention, and combination thereof, provide software solutions for detecting a flight emergency and executing solutions for the emergency. As described in greater detail in this specification, embodiments of the present invention detect a sensor alert associated a variety of aircraft components and executes an alert solution associated with the sensor alert. Various alerts can be a component fire, freezing conditions, engine failure, landing gear malfunction, low fuel, and stall conditions. In further embodiments, if the aircraft is projected for a crash condition, the system deploys a set of parachutes to slow the aircraft for impact.

Implementation of embodiments of the invention may take a variety of forms, and exemplary implementation details are discussed subsequently with reference to the figures. Several embodiments may be presented herein. It should be understood that various components, parts, and features of the different embodiments may be combined together and/or interchanged with one another, all of which are within the scope of the present application, even though not all variations and particular embodiments are shown in the drawings. It should also be understood that the mixing and matching of features, elements, and/or functions between various embodiments is expressly contemplated herein so that one of ordinary skill in the art would appreciate from this disclosure that the features, elements, and/or functions of one embodiment may be incorporated into another embodiment as appropriate, unless otherwise described.

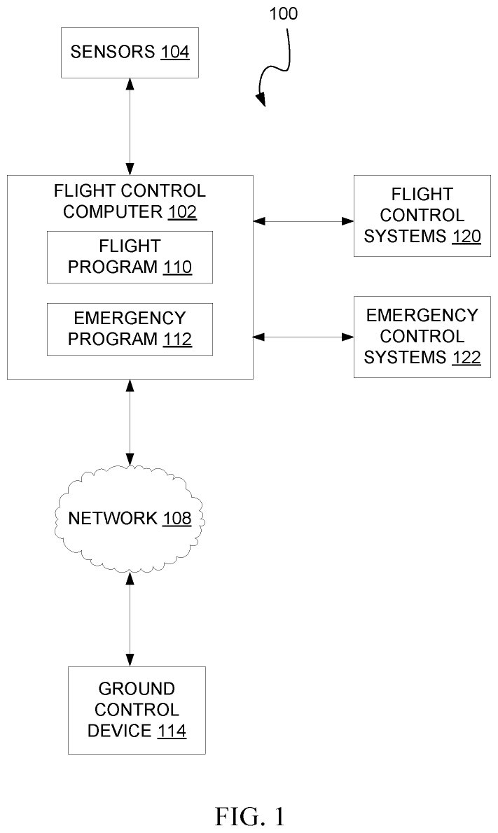

FIG. 1 is a functional block diagram illustrating a communication environment, generally designated 100, in accordance with one embodiment of the present invention. FIG. 1 provides only an illustration of one implementation and does not imply any limitations with regard to the environments in which different embodiments may be implemented. Many modifications to the depicted environment may be made by those skilled in the art without departing from the scope of the invention as recited by the claims.

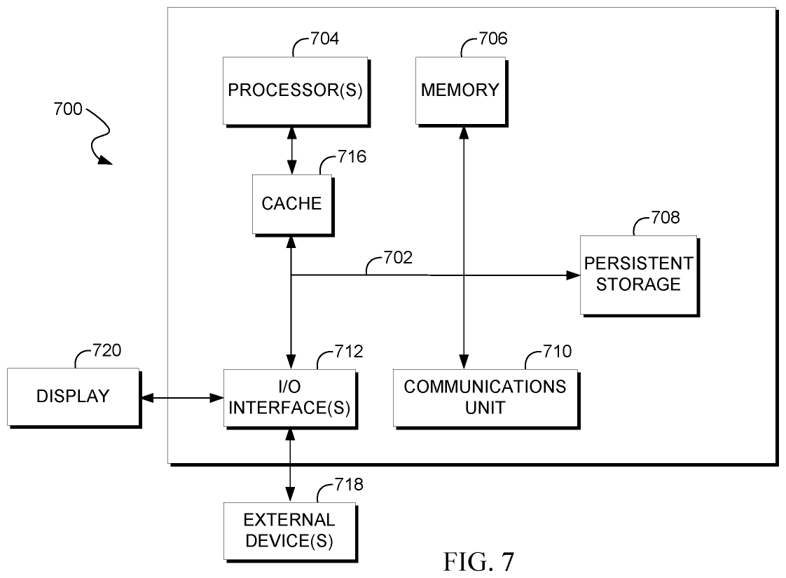

Communication environment 100 includes flight control computer 102, sensors 104, flight control systems 120, emergency control systems 122, and ground control device 114, wherein sensors 104, flight control computer 102, flight control systems 120, and emergency control systems 122 are interconnected over a wired network, and flight control computer 102 and ground control device 114 are interconnected over network 108. Flight control computer 102 and ground device 114 can be a standalone computing device, a management server, a webserver, a mobile computing device, or any other electronic device or computing system capable of receiving, sending, and processing data. In other embodiments, flight control computer 102 and ground device 114 can represent a server computing system utilizing multiple computers as a server system, such as in a cloud computing environment. In another embodiment, flight control computer 102 and ground device 114 can be a laptop computer, a tablet computer, a netbook computer, a personal computer (PC), a desktop computer, a personal digital assistant (PDA), a smart phone, or any programmable electronic device capable of communicating with various components and other computing devices (not shown) within communication environment 100. In another embodiment, flight control computer 102 and ground device 114 each represent a computing system utilizing clustered computers and components (e.g., database server computers, application server computers, etc.) that act as a single pool of seamless resources when accessed within communication environment 100. Flight control computer 102 and ground device 114 may include internal and external hardware components capable of executing machine-readable program instructions, as depicted and described in further detail with respect to FIG. 7.

Ground control device 114 is a computing device generally associated with ground control services that communicate with a pilot and corresponding aircraft via flight computer 102.

Flight control computer 102 includes flight program 110 and emergency program 112. In general, flight control computer 102 is a computer used generally for aircraft that are “fly-by-wire” wherein movement of flight controls are converted to electronic signals transmitted by wires to a variety of components of the aircraft. Flight control computer 102 receives signals from sensors 104 and determines how to move actuators at each control surface, adjust engine throttle, engage landing gear, and etc. (e.g., flight control systems 120) to provide the ordered response. As used herein, flight program 110 is software known in the art that is generally utilized by a flight control computer to receive pilot inputs and to compute the necessary electronic signals to aircraft components. In some instances, flight program 110 has an autopilot feature that receives a set of flight parameters from a pilot and in turn computes necessary electronic signals to drive actuators that maintain a flight pattern based on the flight parameters. Flight control computer 102 in conjunction with flight program 110 act to stabilize the aircraft and adjust the flying characteristics without the pilot's involvement and to prevent the pilot operating outside the aircraft's safe performance envelope. Furthermore, flight control computer 102 transmits signals to emergency control systems 122.

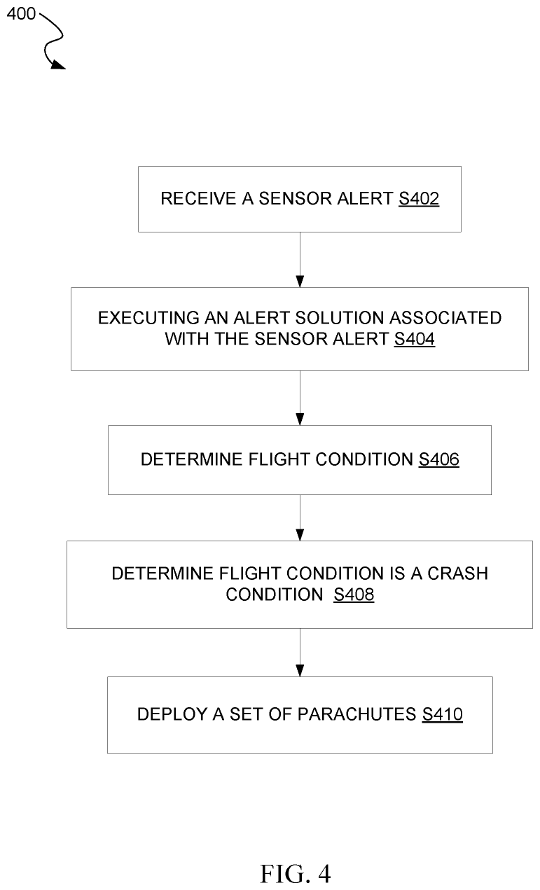

Flight control computer 102 also includes emergency program 112. In general, emergency program 112 detects a sensor alert based on received signals from sensors 104 that are associated a variety of aircraft components. Emergency program 112 executes an alert solution associated with the sensor alert. Various alerts can be a component fire, freezing conditions, engine failure, landing gear malfunction, low fuel, and stall conditions. In some embodiments, emergency program 112 overrides flight program 110. In further embodiments, when emergency program 112 determines the aircraft is projected for a crash condition, the emergency program 112 deploys a set of parachutes to slow the aircraft for impact. Emergency program 112 is depicted and described in further detail with respect to FIG. 4.

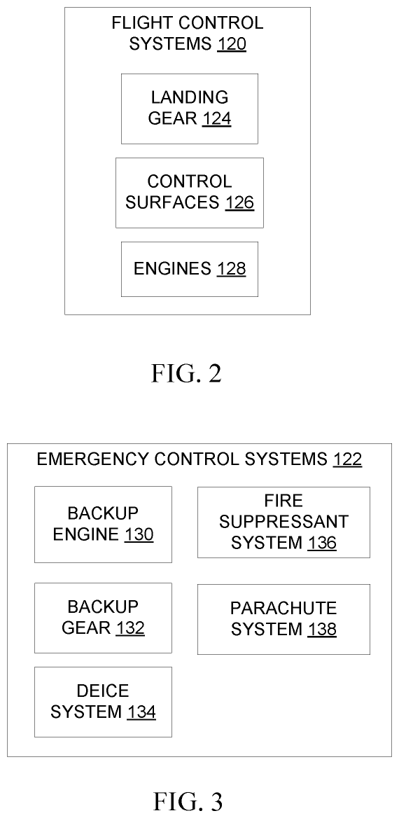

Flight control systems 120 receive transmitted signals from flight control computer 102 and are components of an aircraft responsible for mechanically maintaining and navigating flight. Flight control systems 120 include, but is not limited to, control surfaces (e.g., ailerons, elevators, flaps, airbrakes, rudder, etc.), landing gear, engine throttle actuators. As further depicted in FIG. 2, flight control systems 120 include landing gear 124, control surfaces 126, and engines 128.

Emergency control systems 122 are emergency components of an aircraft. For example, a backup engine, backup landing gear, deicing system, fire suppressant system, and a parachute system. As further depicted in FIG. 3, emergency control systems 122 include backup engine 130, backup gear 132, deice system 134, fire suppressant system 136, and parachute system 138. Components of emergency control systems 122 are further depicted and described in FIGS. 4-6.

Sensors 104 are flight sensors and instruments that monitor the condition of the aircraft as a whole as well as various components of the aircraft. For example, sensors 104 include, but is not limited to, airspeed indicators, attitude indicators, altimeters, vertical speed indicators, heading indicators, turn and slip coordinator. Furthermore, sensors 104 include, but is not limited to, fire sensors corresponding to various components and sections of the aircraft, temperature sensors corresponding to various components and sections of the aircraft, fuel level indicators, landing gear engagement indicators, and engine status sensors (e.g., sensors that measure tachometer, manifold pressure, fuel pressure, etc.). Lastly, sensors 104 also include devices that measure pilot control feedback (e.g., flight stick/yoke, rudder pedals, throttle, etc.). Flight control computer 102 receives signals from sensors 104 to determine flight conditions and transmits signals to flight control systems 120 and emergency control systems 122 based on the received signals.

Network 108 can be, for example, a telecommunications network, a local area network (LAN), a wide area network (WAN), such as the Internet, or a combination of the three. Network 108 can include one or more wireless networks that are capable of receiving and transmitting data, voice, and/or video signals, including multimedia signals that include voice, data, and video information. In general, network 108 can be any combination of connections and protocols that will support communications among flight control computer 102, ground control device 114, and other computing devices (not shown) within communication environment 100.

FIG. 4 is a flowchart 400 depicting operational steps of an emergency program executing solutions for a flight emergency, in accordance with an embodiment of the present invention.

In step S402, emergency program 112 receives a sensor alert. In one embodiment, emergency program 112 receives a sensor alert by receiving a transmitted signal from sensors 104, compares the received signal to a set of acceptable signal parameters, and determines the signal is outside the set of acceptable signal parameters. In another embodiment, emergency program 112 receives a sensor alert by receiving a transmitted signal from sensors 104 wherein receipt of the signal indicates a sensor alert.

In one embodiment, emergency program 112 receives a sensor alert from sensors 104 wherein the sensor alert corresponds to a fire alert such that sensors 104 is a fire detection device. In this embodiment, the fire detection device is a temperature gauge that measures temperatures of an aircraft component. In this embodiment, emergency program 112 determines a sensor alert by receiving a signal from the temperature gauge and determines the temperature of the aircraft component exceeds a temperature threshold which corresponds to a fire. In another embodiment, the fire detection device is a device that only transmits a signal upon measuring a temperature that exceeds a temperature threshold. In this embodiment, emergency program 112 receives a signal from the fire detection device only when the fire detection device is triggered by measuring a temperature exceeding a temperature threshold.

In one embodiment, emergency program 112 receives a sensor alert from sensors 104 wherein the sensor alert corresponds to a freezing alert such that sensors 104 is a device that measures freezing conditions that indicate an environment that permits ice to form on aircraft components.

In one embodiment, emergency program 112 receives a sensor alert from sensors 104 wherein the sensor alert corresponds to engine failure or malfunction such that sensors 104 is a device or a combination of device that determine an engine of the aircraft has malfunctioned or failed.

In one embodiment, emergency program 112 receives a sensor alert from sensors 104 wherein the sensor alert corresponds to a landing gear deployment failure such that sensors 104 is a device that determines whether a set of landing gear of a plurality of landing gear of the plane have failed to engage into a landing position.

In one embodiment, emergency program 112 receives a sensor alert from sensors 104 wherein the sensor alert corresponds to low fuel such that sensors 104 is a device that measures fuel levels of a fuel reservoir to the aircraft.

In step S404, in response to receiving a sensor alert, emergency program 112 executes an alert solution associated with the sensor alert. In one embodiment, in response to receiving a fire alert corresponding to a component of the aircraft, emergency program 112 executes an alert solution by transmitting a signal to fire suppressant system 136 of emergency control systems 122 to extinguish the detected fire at the corresponding component of the aircraft.

In one embodiment, in response to receiving a freezing alert corresponding to a component of the aircraft, emergency program 112 executes an alert solution by transmitting a signal to deice system 134 of emergency control systems 122 to deice the corresponding component of the aircraft.

In one embodiment, in response to receiving an engine failure or malfunction alert, emergency program 112 executes an alert solution by transmitting a signal to backup engine 130 of emergency control systems 122 to deploy an emergency backup engine. In this embodiment, emergency program 112 deploys an emergency engine by transmitting signals corresponding to opening a door to a housing compartment that stores a backup engine in the aircraft fuselage, extending the backup engine using a cantilever system in communication between the backup engine and the aircraft, and activating the backup engine thereby providing emergency thrust for the aircraft. In a further embodiment, emergency program 112 overrides flight program 110 controls components of flight control systems 120 as an autopilot system in order to allow pilots of the aircraft to divert attention to towards restarting the failed or malfunction engine of the aircraft.

In one embodiment, in response to receiving an alert corresponding to landing gear deployment failure, emergency program 112 executes an alert solution by transmitting a signal to backup gear 132 of emergency control systems 122 to deploy backup landing gear.

In one embodiment, in response to receiving a low fuel alert while the aircraft is on the ground (i.e., at an aircraft terminal or taxiing on a tarmac), emergency program 112 overrides flight program 110 and terminates all functions of flight control systems 120 (i.e., disengaging engines, locking engine throttle controls, and locking flight control surfaces) thus preventing the aircraft from proceeding further towards taking off.

In step S406, in response to executing an alert solution associated with the sensor alert, emergency program 112 determines flight conditions of the aircraft. In this embodiment, emergency program 112 determines flight conditions of the aircraft by continuously monitoring sensors 104. In one embodiment, in response to emergency program 112 determining the sensor alert is resolved such that the problem has been corrected (i.e., malfunctioned engines resume normal operation, components are no longer in freezing conditions, components are no longer on fire, plane has been refueled, etc.), then emergency program 112 terminates the alert solution (i.e., emergency program 112 terminates functions carried out by emergency control systems 122) and resumes normal operation.

In step S408, while determining flight conditions of the aircraft, emergency program 112 determines flight conditions is a crash condition. In this embodiment, emergency program 112 determines a crash condition, wherein a crash condition indicates that the aircraft is projected to crash based on based measurements of sensors 104. For example, emergency program 112 determines based on a combination of measurements taken from airspeed indicators, attitude indicators, altimeters, vertical speed indicators, heading indicators, turn and slip coordinator that the plane is projected crash due to aircraft stall and/or high speeds towards the ground.

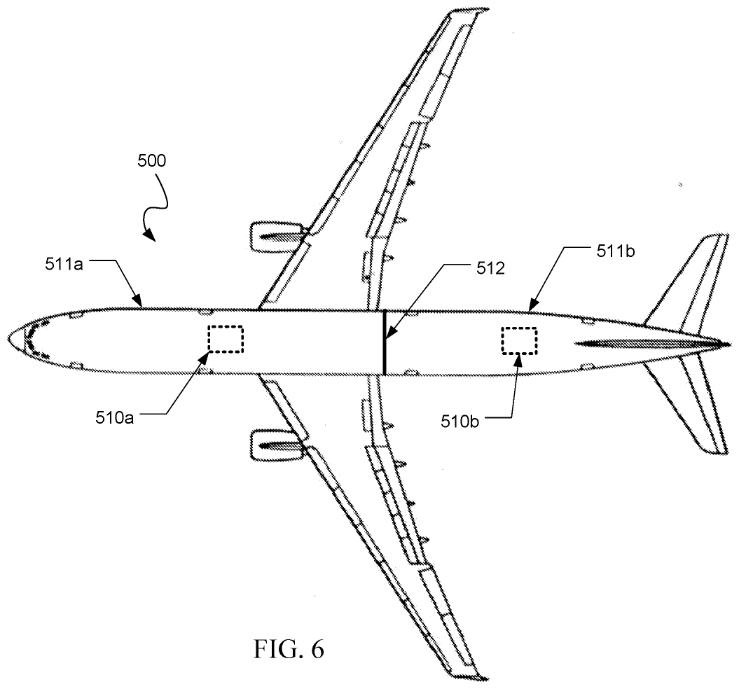

In step S410, responsive to determining flight condition is a crash condition, emergency program 112 deploys a set of parachutes. In this embodiment, emergency program 112 transmits a signal to parachute system 138 of emergency control systems 122 to deploy a set of parachutes. In a further embodiment, emergency program 112 also transmits a signal to a separation band that separates a first section of the plane from a second section of the plane wherein the a first parachute is deployed in communication with the first section and a second parachute is deployed in communication with the second section. Parachute system 138 is further depicted and described in FIG. 6.

In a further embodiment, emergency program 112 periodically transmits a text communication to a ground control device via network 108, wherein the text communication comprises map coordinates and directional coordinates associated with the aircraft at the time of transmission. In this embodiment, the time period between each text transmission is a predetermined amount of time.

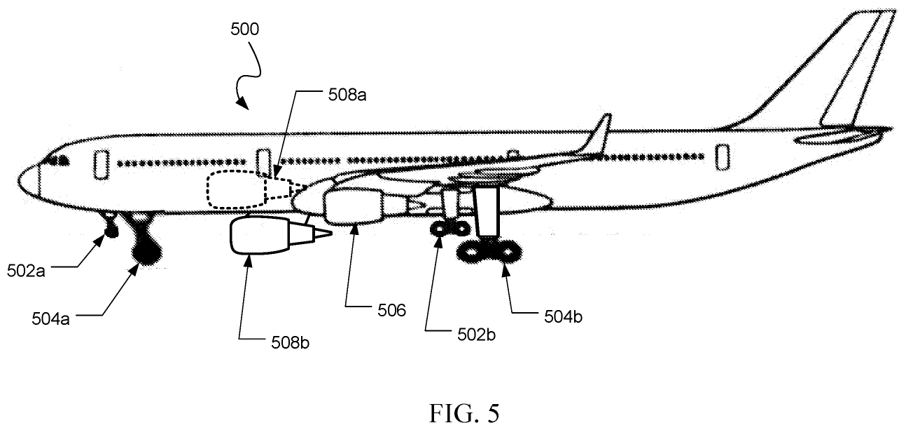

Now in reference to FIG. 5, a side view of plane 500 outfitted with emergency controls systems 122 is depicted in accordance with an embodiment of the present invention.

In this embodiment, plane 500 is an aircraft that generally has landing gear (i.e., landing gear 502a-b) and engines (i.e., engines 506). Furthermore, plane 500 is outfitted with emergency control systems 122 which include backup engine 130, backup gear 132, deice system 134, fire suppressant system 136, and parachute system 138. In this figure, backup gear 132 comprise landing gear 504a-b, wherein landing gear 504a-b are landing gear that extends beyond the height of landing gear 502a-b such that landing gear 502a-b structurally support plane 500 landing impact in lieu of landing gear 502a-b. In this figure, backup engine 130 is depicted in engaged position 508b and storage position 508a. During normal operation, backup engine 130 is stored in storage position 508a in a fuselage of plane 500. During an emergency, such as an engine malfunction, backup engine 130 is deployed to engaged position 508b and provides emergency thrust for the aircraft.

Now in reference to FIG. 6, a top view of plane 500 outfitted with emergency control systems is depicted in accordance with an embodiment of the present invention.

In this embodiment, parachute system 138 comprise of parachutes 510a-b that are parachutes that slow the aircraft from imminent ground impact. In the event of emergency program 112 determining flight condition is a crash condition, parachutes 510a-b deploy. In a further embodiment, parachutes 510a-b each comprise a primary parachute and a drogue parachute. In this embodiment, emergency program 112 deploys drogue parachutes first to slow plane 500 from airspeeds higher than performance thresholds of the primary parachutes. Once the plane 500 slows to an airspeed below the performance threshold of the primary parachute, emergency program 112 deploys the primary parachutes. In further embodiments, plane 500 has separation band 512 separates a first section of the plane from a second section of the plane. In some embodiments, separation band 512 is a locking mechanism. In other embodiments, separation band 512 is local explosive that structurally separates the plane. In this figure, separation band separates plane section 511a from plane section 511b.

FIG. 7 depicts a block diagram of components of computing systems within communication environment 100 of FIG. 1, in accordance with an embodiment of the present invention. It should be appreciated that FIG. 4 provides only an illustration of one implementation and does not imply any limitations with regard to the environments in which different embodiments can be implemented. Many modifications to the depicted environment can be made.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

Computer system 700 includes communications fabric 702, which provides communications between cache 716, memory 706, persistent storage 708, communications unit 710, and input/output (I/O) interface(s) 712. Communications fabric 702 can be implemented with any architecture designed for passing data and/or control information between processors (such as microprocessors, communications and network processors, etc.), system memory, peripheral devices, and any other hardware components within a system. For example, communications fabric 702 can be implemented with one or more buses or a crossbar switch.

Memory 706 and persistent storage 708 are computer readable storage media. In this embodiment, memory 706 includes random access memory (RAM). In general, memory 706 can include any suitable volatile or non-volatile computer readable storage media. Cache 716 is a fast memory that enhances the performance of computer processor(s) 704 by holding recently accessed data, and data near accessed data, from memory 706.

Emergency program 112 may be stored in persistent storage 708 and in memory 706 for execution by one or more of the respective computer processors 704 via cache 716. In an embodiment, persistent storage 708 includes a magnetic hard disk drive. Alternatively, or in addition to a magnetic hard disk drive, persistent storage 708 can include a solid state hard drive, a semiconductor storage device, read-only memory (ROM), erasable programmable read-only memory (EPROM), flash memory, or any other computer readable storage media that is capable of storing program instructions or digital information.

The media used by persistent storage 708 may also be removable. For example, a removable hard drive may be used for persistent storage 708. Other examples include optical and magnetic disks, thumb drives, and smart cards that are inserted into a drive for transfer onto another computer readable storage medium that is also part of persistent storage 708.

Communications unit 710, in these examples, provides for communications with other data processing systems or devices. In these examples, communications unit 710 includes one or more network interface cards. Communications unit 710 may provide communications through the use of either or both physical and wireless communications links. Emergency program 112 may be downloaded to persistent storage 708 through communications unit 710.

I/O interface(s) 712 allows for input and output of data with other devices that may be connected to server computer 102, player device 104, and/or collector device 106. For example, I/O interface 712 may provide a connection to external devices 718 such as a keyboard, keypad, a touch screen, and/or some other suitable input device. External devices 718 can also include portable computer readable storage media such as, for example, thumb drives, portable optical or magnetic disks, and memory cards. Software and data used to practice embodiments of the present invention, e.g., Faithful program 110, can be stored on such portable computer readable storage media and can be loaded onto persistent storage 708 via I/O interface(s) 712. I/O interface(s) 712 also connect to a display 720.

Display 720 provides a mechanism to display data to a user and may be, for example, a computer monitor.

The present invention may be a system, a method, and/or a computer program product. The computer program product may include a computer readable storage medium (or media) having computer readable program instructions thereon for causing a processor to carry out aspects of the present invention.

The computer readable storage medium can be any tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, a special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, a segment, or a portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A computer-implemented method on an aircraft comprising:
receiving a sensor alert;
responsive to receiving the sensor alert, executing an alert solution associated with the sensor alert;
responsive to executing the alert solution, determining flight condition;
determining flight condition is a crash condition; and
responsive to determining flight condition is a crash condition, deploying a set of parachutes.

2) The method of claim 1, wherein:
the sensor alert is a fire alert,
the alert solution associated with the sensor alert comprises deploying a fire suppressant system.

3) The method of claim 1, wherein:
the sensor alert is a freezing alert,
the alert solution associated with the sensor alert comprises deploying a deicing system.

4) The method of claim 1, wherein:
the sensor alert is engine failure,
the alert solution associated with the sensor alert comprises deploying a backup engine.

5) The method of claim 1, wherein:
the sensor alert is landing gear deployment failure,
the alert solution associated with the sensor alert comprises deploying backup landing gear.

6) The method of claim 1, wherein:
the sensor alert is low fuel,
the alert solution associated with the sensor alert comprises turning off aircraft engines, locking engine throttle, and locking flight control surfaces.

7) The method of claim 1, further comprising:
determining sensor alert is resolved, and
terminating the alert solution associated with the sensor alert.

8) The method of claim 1, further comprising:
Transmitting a text communication periodically to a ground control device, wherein time between each text is a predetermined amount of time, and wherein the text communication comprises map coordinates and directional coordinates of the aircraft at the time of transmission.

9) The method of claim 1, wherein deploying a set of parachutes further comprises separating the aircraft into a first section and a second section based on a separation band.

10) A computer program product comprising:
one or more computer readable storage media and program instructions stored on the one or more computer readable storage media, the program instructions comprising:
program instructions to receive a sensor alert;
responsive to receiving the sensor alert, program instructions to execute an alert solution associated with the sensor alert;
responsive to executing the alert solution, program instructions to determine flight condition;
program instructions to determine flight condition is a crash condition; and
responsive to determining flight condition is a crash condition, program instructions to deploying a set of parachutes.

11) The computer program product of claim 10, wherein:
the sensor alert is a fire alert,
the alert solution associated with the sensor alert comprises deploying a fire suppressant system.

12) The computer program product of claim 10, wherein:
the sensor alert is a freezing alert,
the alert solution associated with the sensor alert comprises deploying a deicing system.

13) The computer program product of claim 10, wherein:
the sensor alert is engine failure,
the alert solution associated with the sensor alert comprises deploying a backup engine.

14) The computer program product of claim 10, wherein:
the sensor alert is landing gear deployment failure,
the alert solution associated with the sensor alert comprises deploying backup landing gear.

15) The computer program product of claim 10, wherein:
the sensor alert is low fuel,
the alert solution associated with the sensor alert comprises turning off aircraft engines, locking engine throttle, and locking flight control surfaces.

16) The computer program product of claim 10, further comprising:
program instructions to determine sensor alert is resolved, and
program instructions to terminate the alert solution associated with the sensor alert.

17) The computer program product of claim 10, further comprising:
program instructions to transmit a text communication periodically to a ground control device, wherein time between each text is a predetermined amount of time, and wherein the text communication comprises map coordinates and directional coordinates of the aircraft at the time of transmission.

18) The computer program product of claim 10, wherein program instructions to deploy a set of parachutes further comprises program instructions to separate the aircraft into a first section and a second section based on a separation band.

19) A computer system comprising:
one or more computer processors;
one or more computer readable storage media; and
program instructions stored on the one or more computer readable storage media for execution by at least one of the one or more processors, the program instructions comprising:
program instructions to receive a sensor alert;
responsive to receiving the sensor alert, program instructions to execute an alert solution associated with the sensor alert;
responsive to executing the alert solution, program instructions to determine flight condition;
program instructions to determine flight condition is a crash condition; and
responsive to determining flight condition is a crash condition, program instructions to deploying a set of parachutes.

20) The computer system of claim 19, further comprising:
program instructions to transmit a text communication periodically to a ground control device, wherein time between each text is a predetermined amount of time, and wherein the text communication comprises map coordinates and directional coordinates of the aircraft at the time of transmission.
